(19) United States
(12) Patent Application Publication
(10) Pub. No.: US 2026/0340820 A1
(43) Pub. Date: Oct. 29, 2026

(54) ARTIFICIAL-MEDICAL-IMAGE GENERATION APPARATUS, ARTIFICIAL-MEDICAL-IMAGE GENERATION METHOD, AND MEDICAL IMAGE DIAGNOSTIC APPARATUS

(71) Applicant: CANON MEDICAL SYSTEMS CORPORATION, Otawara-shi (JP)

(72) Inventor: Hidenori TAKESHIMA, Taito (JP)

(73) Assignee: CANON MEDICAL SYSTEMS CORPORATION, Otawara-shi (JP)

(21) Appl. No.: 19/541,663

(22) Filed: Feb. 17, 2026

(30) Foreign Application Priority Data
Apr. 23, 2025 (JP) 2025-071550

(51) Int. Cl. G06T 7/00; G06T 7/30

(52) U.S. Cl. CPC G06T 7/0012; G06T 7/30; G06T 2207/10081; G06T 2207/10088; G06T 2207/20081

(57) ABSTRACT

An artificial-medical-image generation apparatus according to an embodiment includes processing circuitry. The processing circuitry obtains lower-dimensional data which is data lower in dimension than a medical image to be presented to a user. The processing circuitry inputs the lower-dimensional data into a pretrained generative model to generate an artificial medical image being higher in dimension than the lower-dimensional data. The pretrained generative model has learned to generate an artificial medical image from an input of data being lower in dimension than the medical image. The processing circuitry outputs the artificial medical image.

### CROSS-REFERENCE TO RELATED APPLICATION

This application is based upon and claims the benefit of priority from Japanese Patent Application No. 2025-071550, filed on Apr. 23, 2025; the entire contents of which are incorporated herein by reference.

### FIELD

Embodiments described herein relate generally to an artificial-medical-image generation apparatus, an artificial-medical-image generation method, and a medical image diagnostic apparatus.

### BACKGROUND

Conventionally, to use a medical image generation apparatus incorporating image generative artificial intelligence (AI), there are certain regulations to be satisfied. An example of such regulations are the ones issued by the Food and Drug Administration (FDA) in the U.S.

Such regulations may specify, for example, prevention of occurrence of hallucinations in medical images generated using an image generative AI (hereinafter, artificial images), the hallucinations which would otherwise induce misdiagnoses. A magnetic resonance imaging (MRI) apparatus, as an exemplary medical image diagnostic apparatus, incorporating image generative AI is subjected to such regulations with respect to artificial magnetic resonance (MR) images.

In a traditional MRI apparatus, localizer imaging (locator) is performed prior to a main scan of a subject concerned to set the imaging range of the main scan. In locator images obtained by the locator, locations along the body axis of the subject are set in accordance with an object or a region to be captured. Thus, only a small amount of information contained in the locator image may be used for localization in preparation for a main scan.

### BRIEF DESCRIPTION OF THE DRAWINGS

FIG. 1 is a schematic block diagram illustrating an exemplary configuration of a magnetic resonance imaging (MRI) apparatus according to one embodiment;

FIG. 2 illustrates an example of two one-dimensional scans of a subject according to one embodiment;

FIG. 3 is a flowchart illustrating steps of an artificial-medical-image generation process according to one embodiment, as an example;

FIG. 4 schematically illustrates a flow of an artificial-medical-image generation process according to one embodiment, as an example; and

FIG. 5 illustrates an example of an artificial superimposed image obtained in an artificial-medical-image generation process according to one embodiment.

### DETAILED DESCRIPTION

A magnetic resonance imaging apparatus according to one embodiment includes processing circuitry. The processing circuitry obtains lower-dimensional data which is data lower in dimension than a medical image to be presented to a user. The processing circuitry inputs the lower-dimensional data into a pretrained generative model to generate an artificial medical image being higher in dimension than the lower-dimensional data. The pretrained generative model has learned to generate an artificial medical image from an input of data being lower in dimension than the medical image. The processing circuitry then outputs the artificial medical image.

Hereinafter, exemplary embodiments of an artificial- medical-image generation apparatus, an artificial-medical-image generation method, and a medical image diagnostic apparatus will be described in detail with reference to the accompanying drawings. Herein, an artificial-medical-image generation apparatus is considered to be mounted on a medical image diagnostic apparatus for the sake of specificity. More specifically, a magnetic resonance imaging (MRI) apparatus will be explained as an example of the medical image diagnostic apparatus incorporating the artificial-medical-image generation apparatus. Such an artificial-medical-image generation apparatus may also be referred to as an artificial-MR-image generation apparatus.

In addition to being incorporated in the MRI apparatus, the artificial-medical-image generation apparatus of one embodiment may be implemented by any of a variety of server devices such as a cloud server. Further, the artificial-medical-image generation apparatus may be incorporated in an X-ray computed tomography (CT) apparatus. An example of an X-ray CT apparatus including the artificial-medical-image generation apparatus will be explained later as an exemplary application. Throughout the following embodiments, parts, portions, elements, or functions denoted by the same reference numerals are considered to perform same or similar operations, and an overlapping explanation thereof will be omitted when appropriate.

### Embodiment

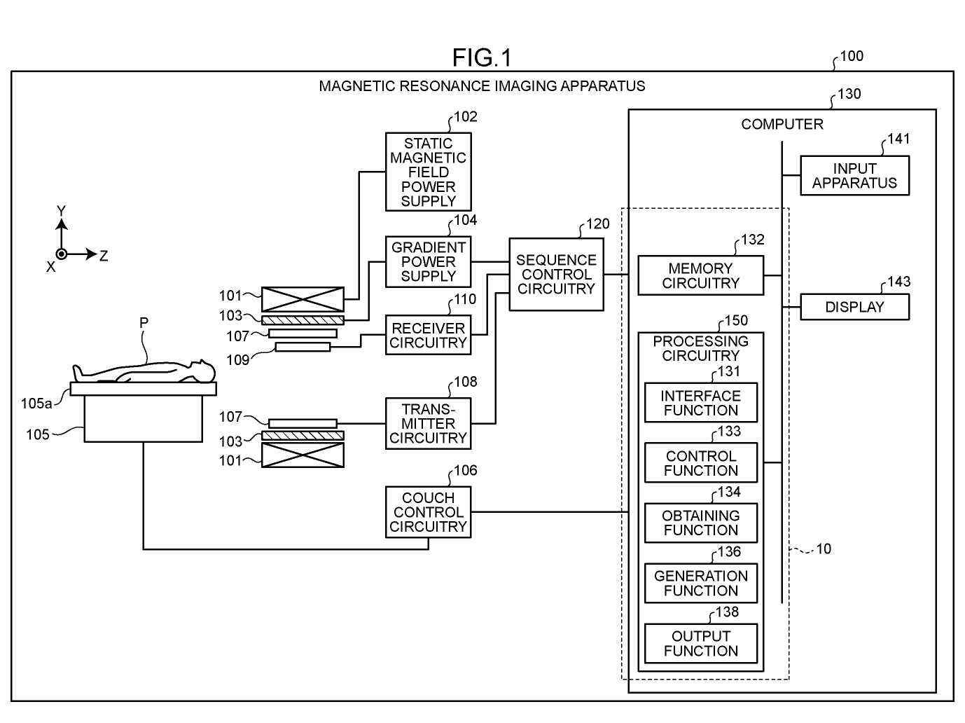

FIG. 1 is a schematic block diagram of an exemplary configuration of an MRI apparatus 100 according to one embodiment. As illustrated in FIG. 1, the MRI apparatus 100 includes static magnetic field magnets 101, a static magnetic field power supply 102, gradient coils 103, a gradient power supply 104, a couch 105, couch control circuitry 106, transmitter coils 107, transmitter circuitry 108, a receiver coil 109, receiver circuitry 110, sequence control circuitry 120, and a computer 130. The MRI apparatus 100 does not include a subject P (such as a human body). An artificial-medical-image generation apparatus 10 is indicated by the broken-line frame in FIG. 1. The structure and configuration illustrated in FIG. 1 are presented for illustrative purpose only.

The respective elements of the sequence control circuitry 120 and the computer 130 may be integrated or separated when appropriate. The gantry in the MRI apparatus 100 includes, for example, the static magnetic field magnets 101, the static magnetic field power supply 102, the gradient coils 103, the gradient power supply 104, the transmitter coils 107, the transmitter circuitry 108, the receiver coil 109, the receiver circuitry 110, and the sequence control circuitry 120. The gantry may additionally include a display 143.

In addition, the MRI apparatus 100 may be connected to an optical imaging device in a known method, e.g., in a wired or wireless manner. The optical imaging device can be disposed on the ceiling of an examination room where the MRI apparatus 100 is installed, for example. Specifically, the optical imaging device may be disposed on the ceiling immediately above a couch 105 of the MRI apparatus 100. The optical imaging device can be disposed at an optional location in addition to the ceiling of the examination room as long as it can capture an entire couchtop 105a of the couch 105. The optical imaging device optically captures an object or objects present in the imaging range of the optical imaging device constantly or in response to a user instruction. The optical imaging device generates images of an object or objects present in its own imaging range (hereinafter, optical images).

The optical imaging device transmits optical images to the MRI apparatus 100. The optical imaging device corresponds to, for example, an optical camera. An optical image may also be referred to as a camera image. Further, the optical imaging device may be included in the MRI apparatus 100. Any of known optical imaging devices is applicable so that a description thereof is omitted.

The static magnetic field magnets 101 are hollow, substantially cylindrical magnets to generate static magnetic fields in the internal space. Examples of the static magnetic field magnet 101 include a superconducting magnet that magnetizes, supplied with a current from the static magnetic field power supply 102. The static magnetic field power supply 102 supplies currents to the static magnetic field magnets 101. The static magnetic field magnets 101 can be permanent magnets. In this case the MRI apparatus 100 may not include the static magnetic field power supply 102. The static magnetic field power supply 102 may be separated from the MRI apparatus 100.

The gradient coils 103 have a hollow, substantially cylindrical shape and are located inside the static magnetic field magnets 101. Each gradient coil 103 is a combination of three coils corresponding to mutually orthogonal X-axis, Y-axis, and Z-axis. The three coils are individually supplied with currents from the gradient power supply 104, to generate gradient fields that vary in field strength along the X, Y, and Z-axes, respectively. The gradient fields generated along the X, Y, and Z-axes by the gradient coils 103 are exemplified by a slice gradient field Gs, a phase-encoding gradient field Ge, and a readout gradient field Gr. The gradient power supply 104 supplies currents to the gradient coils 103.

The couch 105 includes a couchtop 105a on which the subject P is to be laid. Under the control of the couch control circuitry 106, the couch 105 with the subject P lying thereon is inserted into a hollow space (imaging region) of the gradient coils 103. The couch 105 is typically installed in such a manner that its longitudinal side is parallel to the axes of the static magnetic field magnets 101. The couch control circuitry 106 drives the couch 105 to move the couchtop 105a longitudinally and vertically under the control of the computer 130.

The transmitter coils 107 are located inside the gradient coils 103, to generate high-frequency magnetic fields, supplied with RF pulses from the transmitter circuitry 108. The transmitter circuitry 108 supplies RF pulses corresponding to the Larmor frequency to the transmitter coils 107. The Larmor frequency is defined by a type of target atoms and a magnetic field strength.

The receiver coil 109 is located inside the gradient coils 103, to receive magnetic resonance (MR) signals which are issued from the subject P due to an influence of the high-frequency magnetic field. The receiver coil 109 outputs the MR signals to the receiver circuitry 110 upon receipt.

The transmitter coils 107 and the receiver coil 109 as described above are presented for illustrative purpose only. Each of the transmitter coils 107 and the receiver coil 109 may be one or a combination of a coil having a transmission function alone, a coil having a reception function alone, and a coil having both transmission and reception functions.

The receiver circuitry 110 detects MR signals output from the receiver coil 109 and generates MR data from the detected MR signals. Specifically, the receiver circuitry 110 generates MR data by converting the MR signals output from the receiver coil 109 into digital signals. The receiver circuitry 110 transmits the MR data to the sequence control circuitry 120. The receiver circuitry 110 may be included in the gantry equipped with the static magnetic field magnets 101, the gradient coils 103, and other elements.

The sequence control circuitry 120 performs imaging of the subject P by driving the gradient power supply 104, the transmitter circuitry 108, and the receiver circuitry 110 based on sequence information transmitted from the computer 130. Herein, the sequence information represents information including defined imaging procedures and may be simply referred to as a sequence condition. The sequence information includes definitions of current intensity and current supply timing from the gradient power supply 104 to the gradient coils 103, RF pulse intensity and RF pulse application timing from the transmitter circuitry 108 to the transmitter coils 107, and MR-signal detection timing by the receiver circuitry 110, for example.

Examples of the sequence control circuitry 120 include integrated circuitry such as an application specific integrated circuit (ASIC) and a field programmable gate array (FPGA), and electronic circuitry such as a central processing unit (CPU) and a micro processing unit (MPU). The sequence control circuitry 120 corresponds to a sequence control unit and may be referred to as an imaging unit. The imaging unit may correspond to the gantry in the MRI apparatus 100.

After the subject P has been imaged as a result of driving the gradient power supply 104, the transmitter circuitry 108, and the receiver circuitry 110, the sequence control circuitry 120 receives MR data from the receiver circuitry 110 and transfers the MR data to the computer 130.

The computer 130 performs overall control of the MRI apparatus 100 and generates images, for example. The computer 130 includes memory circuitry 132, an input apparatus 141, a display 143, and processing circuitry 150. The processing circuitry 150 includes an interface function 131, a control function 133, an obtaining function 134, an generation function 136, and an output function 138.

The processing and functions to be performed by the interface function 131, the control function 133, the obtaining function 134, the generation function 136, and the output function 138 are stored in the memory circuitry 132 in the form of computer program executable by the computer 130. The processing circuitry 150 is a processor that retrieves and executes the computer programs from the memory to implement the functions corresponding to the respective computer programs. In other words, having retrieved the computer programs, the processing circuitry 150 includes the respective functions shown in the processing circuitry 150 of FIG. 1.

FIG. 1 depicts an example that the single piece of sequence control circuitry 120 implements the interface function 131, control function 133, obtaining function 134, generation function 136, and output function 138. Alternatively, the processing circuitry 150 may be constituted of a combination of independent processors so that the processors can individually implement the functions by executing the computer programs. In other words, the above functions may be configured as individual computer programs to be executed by the single piece of processing circuitry 150, or particular function or functions may be incorporated in dedicated, independent program-executable circuitry.

The term "processor" used herein signifies, for example, circuitry such as a CPU, an application specific integrated circuit, and a programmable logic device (e.g., a simple programmable logic device (SPLD), a complex programmable logic device (CPLD), and a field programmable gate array (FPGA)). The processor retrieves and executes the computer programs from the memory circuitry 132 to implement the functions.

In addition, in place of being stored in the memory circuitry 132, the computer programs may be directly embedded in the circuitry of the processor. In such a case the processor retrieves and executes the computer programs from the circuitry to implement the functions. Likewise, the couch control circuitry 106, the transmitter circuitry 108, and the receiver circuitry 110 each include electronic circuitry such as the above processor.

The processing circuitry 150 uses the interface function 131 to transmit sequence information to the sequence control circuitry 120 and receive MR data from the sequence control circuitry 120. The interface function 131 of the processing circuitry 150 stores the MR data in the memory circuitry 132 upon receipt. The interface function 131 also stores optical images of the subject P in the memory circuitry 132 upon receipt from the optical imaging device. The processing circuitry 150 implementing the interface function 131 corresponds to an interface unit. The rest of the functions of the processing circuitry 150 will be described later.

The memory circuitry 132 stores therein various kinds of MR data and optical images as received by the interface function 131 of the processing circuitry 150, various kinds of data obtained by the obtaining function 134, various kinds of image data generated by the generation function 136, generative models to be used by the generation function 136, and various kinds of data to be output by the output function 138, for example. The memory circuitry 132 further stores MR data arranged by the control function 133 in k-space (also referred to as k-space data). The various kinds of stored data and the generative models will be explained later. The memory circuitry 132 can be implemented by, for example, a semiconductor memory device such as random access memory (RAM) or flash memory, a hard disk, or an optical disk. The memory circuitry 132 is an example of a storage unit or a memory.

The input apparatus 141 receives various kinds of instructions and information inputs from the user such as a medical technologist. Examples of the input apparatus 141 include a trackball, a switch button, a mouse, a keyboard, a touchpad that allows input by touch on the operation surface, a touch screen as an integration of a display screen and a touchpad, a non-contact input circuit including an optical sensor, and a voice input circuit. The input apparatus 141 is electrically connected to the processing circuitry 150 to convert user inputs into electrical signals and outputs them to the processing circuitry 150. The input apparatus 141 is an example of an input unit or an operational unit.

In this disclosure, the input apparatus 141 is not limited to the one including physical operational component or components (input interface) as a mouse and a keyboard. Other examples of the input apparatus 141 include electrical-signal processing circuitry that receives an electrical signal corresponding to an input from an external input apparatus separated from the MRI apparatus 100 to output the electrical signal to control circuitry. The input apparatus 141 may be installed in, for example the gantry, in addition to being installed in the computer 130.

Under the control of the control function 133 of the processing circuitry 150, the display 143 displays a graphical user interface (GUI) to allow the user to input imaging conditions as well as displays images generated by the generation function 136 of the processing circuitry 150. Examples of the display 143 include a cathode ray tube (CRT) display, a liquid crystal display (LCD), an organic electroluminescence display (OELD), a light-emitting diode (LED) display, a plasma display, any of other displays known in related art, and a display device as a monitor. The display 143 is an example of a display unit.

The processing circuitry 150 uses the control function 133 to perform overall control of the MRI apparatus 100 to control imaging, image generation, image display, and else. As an example, the control function 133 of the processing circuitry 150 receives an input of an imaging condition (e.g., imaging parameters) via the GUI to generate sequence information according to the input imaging condition. The processing circuitry 150 including the control function 133 transmits the generated sequence information to the sequence control circuitry 120. The processing circuitry 150 implementing the control function 133 corresponds to a control unit and is an example of a control unit.

The processing circuitry 150 uses the obtaining function 134 to obtain lower-dimensional data which refers to data being lower in dimension than a medical image to be presented to the user. Specifically, the obtaining function 134 obtains lower-dimensional data being lower in dimension than an MR image to be presented to the user. When the medical image to be presented is a two-dimensional MR image, the lower-dimensional data is one-dimensional medical data (one-dimensional data). When the medical image to be presented is a three-dimensional MR image, the lower-dimensional data is two-dimensional data or one-dimensional data. In the following, the lower-dimensional data is defined as one-dimensional data for the sake of specific explanation.

Prior to a main scan of the subject P, the sequence control circuitry 120 performs a scan of the subject P to obtain lower-dimensional data (hereinafter, referred to as a lower-dimensional scan). For obtaining one-dimensional data as lower-dimensional data, the lower-dimensional scan corresponds to a one-dimensional scan along the body axis of the subject P (in the longitudinal direction of the couchtop 105a), for example. For obtaining two-dimensional data as lower-dimensional data, the lower-dimensional scan corresponds to a two-dimensional scan of the subject P, for example. A two-dimensional scan of the subject P can be performed by a known method, therefore, a description thereof is omitted.

The one-dimensional scan corresponds to a navigator scan (region-limiting navigator scan) that scans a particular limited region in a direction vertical to the body axis (e.g., the transverse direction of the couchtop 105a). Further, the one-dimensional scan corresponds to a 1D navigator echo for use in, for example, whole heart magnetic resonance coronary angiography (WH MRCA). The 1D navigator echo represents information obtained by applying a 90-degree pulse and a 180-degree pulse in two directions, for example (as disclosed in Taylor AM et al., "MR navigator-echo monitoring of temporal changes in diaphragm position: Implications for MR coronary angiography", J Magn Reson Imaging 1997 Jul-Aug; 7(4): 629-36).

The one-dimensional scan is not limited to the 1D navigator echo above and can be any of various kinds of region-limiting scan (e.g., not a bi-directional region limiting scan but a one-dimensional, one-directional region-limiting scan or a one-directional scan with no region limiting). In addition, the number of one-dimensional scans to perform is not limited to one but may be two or more. The scanning direction of one-dimensional scans is not limited to the body-axis direction and may be set to an optional direction such as the transverse direction of the couchtop 105a or an oblique direction. The length of scanning by the one-dimensional scan can be freely set.

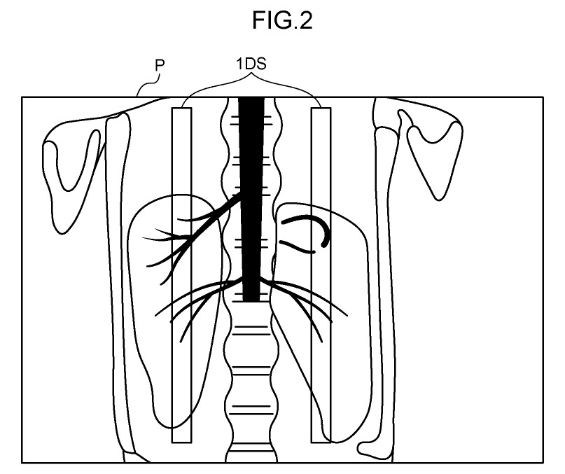

FIG. 2 depicts two one-dimensional scans 1DS of the subject P, as an example. When an object of the subject P to be imaged by a main scan is the liver, two one-dimensional scans 1DS can be, for example, set to vertically cross the diaphragm of the subject P, as illustrated in FIG. 2.

The obtaining function 134 generates lower-dimensional data by reconstructing medical data (MR data) acquired by a one-dimensional scan or a two-dimensional scan (by, for example, performing inverse Fourier transform). Alternatively, the generation function 136 may generate the lower-dimensional data. In a one-dimensional scan being a lower-dimensional scan, the lower-dimensional data corresponds to, for example, a one-dimensional profile (line profile) representing a pixel-value distribution in a one-dimensional scan region (e.g., a line having a predetermined width of one pixel or a certain number of pixels along or in parallel to the body axis) Thus, the lower-dimensional data represents a pixel-value distribution in the scanning direction of the one-dimensional scan.

By performing two or more one-dimensional scans, two or more pieces of lower-dimensional data are generated in the scanning direction of the one-dimensional scans. The lower-dimensional data can be one-dimensional medical data (MR data) acquired by a one-dimensional scan of the subject P. Namely, the lower-dimensional data represents one-dimensional medical data or a one-dimensional profile generated by reconstructing one-dimensional medical data. In other words, the lower-dimensional data corresponds to data generated by a scan (MR scan) conducted prior to a main scan of the subject P.

To present a three-dimensional MR image to the user, the lower-dimensional data may be any of: one-dimensional MR data acquired by a one-dimensional scan of the subject P; a one-dimensional profile generated by reconstruction of the one-dimensional MR data; two-dimensional MR data acquired by a two-dimensional scan of the subject P; or a two-dimensional image generated by reconstruction of the two-dimensional MR data. In this manner, the obtaining function 134 obtains the lower-dimensional data. The obtaining function 134 stores the resultant lower-dimensional data in the memory circuitry 132. The processing circuitry 150 implementing the obtaining function 134 is an example of an obtainer unit.

The processing circuitry 150 uses the generation function 136 to retrieve k-space data collected by a main scan of the subject P from the memory circuitry 132. The generation function 136 then performs reconstruction processing to the k-space data to thereby generate an MR image to be presented to the user. The reconstruction processing can be implemented by a known method, therefore, a description thereof is omitted. The processing circuitry 150 implementing the generation function 136 is an example of a generator unit.

The generation function 136 retrieves a generative model from the memory circuitry 132 prior to a main scan. The generation function 136 then inputs lower-dimensional data into the generative model to generate an artificial medical image (artificial MR image) under the condition of the lower-dimensional data. The generative model is a pretrained generative model that receives input of data being lower in dimension than MR images to be presented to the user to generate artificial MR images. The artificial MR image generated by the generative model corresponds to, for example, a locator image.

The generative model according to the present embodiment corresponds to pretrained image generative AI. The image generative AI is, for example, developed by learning a generative model or models (hereinafter, referred to as a learning target model) such as DALL-E (OpenAI), Stable Diffusion, Firefly (Adobe), or Cycle GAN.

Ground-truth data provided for the learning target model in the learning process is, for example, locator images generated by performing locator scan of human bodies. Training data relative to such ground-truth data corresponds to lower-dimensional data generated by a variety of kinds of lower-dimensional scans of the same human bodies (hereinafter, lower-dimensional training data). The generative model is developed through learning the learning target model that outputs artificial images from input of lower-dimensional training data. The generative model learns to make the artificial images output from the learning target model closer to the ground-truth data. Any of known methods is applicable to the method of learning the learning target model so that a description thereof is omitted.

The generation function 136 may perform positional alignment between an artificial medical image and lower-dimensional data. As an example, the generation function 136 identifies the location of lower-dimensional data in an artificial medical image by a known alignment algorithm. Alternatively, the generation function 136 may identify the location of lower-dimensional data in an artificial medical image according to an imaging condition for a lower-dimensional scan, for instance. The generation function 136 superimposes the lower-dimensional data onto the artificial medical image to generate an artificial superimposed image. The generation function 136 may also generate the artificial superimposed image in a manner that the location of the lower-dimensional data in the artificial superimposed image is identifiable. The generation function 136 stores the resultant artificial MR image and/or artificial superimposed image in the memory circuitry 132.

The processing circuitry 150 uses the output function 138 to output the artificial medical image and/or the artificial superimposed image. For example, the output function 138 allows the artificial MR image and/or the artificial superimposed image to be displayed on the display 143 prior to a main scan of the subject P. The output function 138 further allows the display 143 to display a setting screen for allowing setting of an imaging condition for the subject P, a scanning plan, and else.

The processing circuitry 150 implementing the output function 138 is an example of an output unit. The output function 138 which allows the display of various kinds of images on the display 143 may be referred to as a display control function. The processing circuitry 150 implementing the display control function is an example of a display control unit.

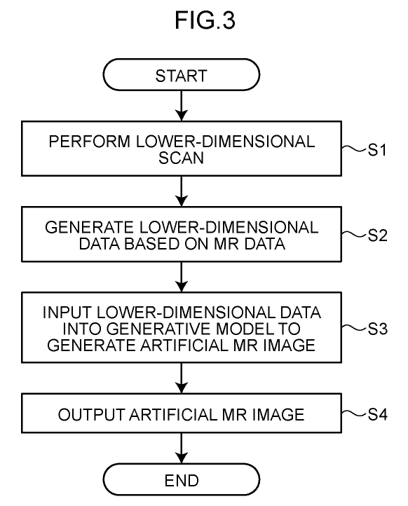

The overall structure and configuration of the MRI apparatus 100 according to some embodiments have been described above. Using the respective elements, the MRI apparatus 100 according to one embodiment performs an artificial-medical-image generation process. In the following, exemplary steps of the artificial-medical-image generation process are explained with reference to FIG. 3. FIG. 3 is a flowchart illustrating the steps of the artificial-medical-image generation process for generating an artificial MR image as an artificial medical image by way of example. This artificial-medical-image generation process may also be referred to as an artificial-MR-image generation process.

### Artificial-Medical-Image Generation Process

### Step S1

The sequence control circuitry 120 performs a lower-dimensional scan of the subject P. Subsequent to the lower-dimensional scan, the interface function 131 receives MR raw data acquired by the lower-dimensional scan as medical data.

### Step S2

The obtaining function 134 generates lower-dimensional data based on the MR raw data. For example, the generation function 136 generates the lower-dimensional data by reconstructing the MR raw data acquired by the lower-dimensional scan. This step is, however, omissible if the MR raw data acquired by the lower-dimensional scan is input to the generative model as lower-dimensional MR data. The obtaining function 134 obtains the lower-dimensional data through the operations in step S1 and step S2.

### Step S3

The generation function 136 retrieves a generative model from the memory circuitry 132. The generation function 136 then inputs the lower-dimensional data into the generative model to allow the generative model to generate an artificial medical image. In the present embodiment the artificial medical image generated by the generative model corresponds to an artificial MR image. In addition, the generation function 136 may generate an artificial superimposed image by superimposing the lower-dimensional data onto the artificial MR image. Further, the generation function 136 may generate the artificial superimposed image in such a manner that the location of the lower-dimensional data in the artificial superimposed image is identifiable. As an example, the generation function 136 generates an artificial superimposed image in a manner that the lower-dimensional data superimposed on the artificial MR image is encircled by a highlighted frame. For another example, the generation function 136 generates an artificial superimposed image in a manner that the lower-dimensional data superimposed on the artificial MR image is highlighted in a preset hue.

### Step S4

The output function 138 outputs the artificial MR image and/or the artificial superimposed image. For example, the output function 138 outputs the artificial MR image and/or the artificial superimposed image to the display 143 for display. Alternatively, the output function 138 may output the artificial MR image and/or the artificial superimposed image to the memory circuitry 132 or a picture archiving and communication system (PACS) connected to the MRI apparatus 100.

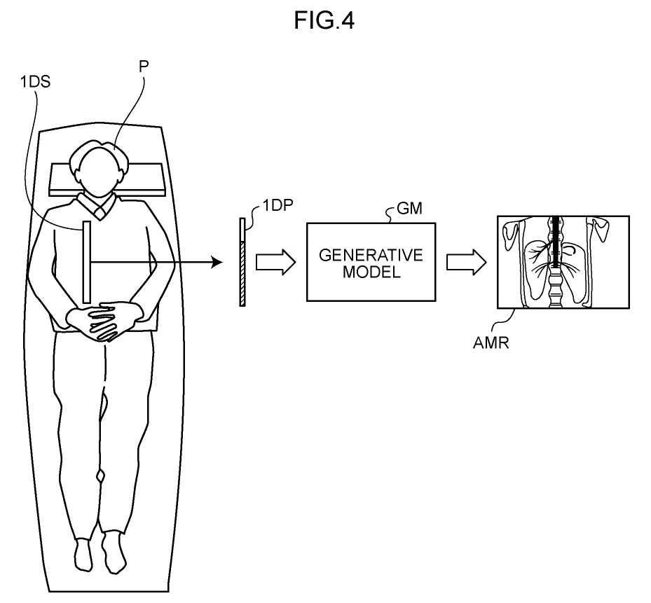

FIG. 4 schematically illustrates a flow of the artificial-medical-image generation process as an example. As illustrated in FIG. 4, the subject P is subjected to a one-dimensional scan 1DS that scans a limited region. One-dimensional data 1DP is then generated as lower-dimensional data by reconstructing MR data collected by the one-dimensional scan 1DS. The one-dimensional data 1DP is then input to a generative model GM to generate an artificial MR image AMR.

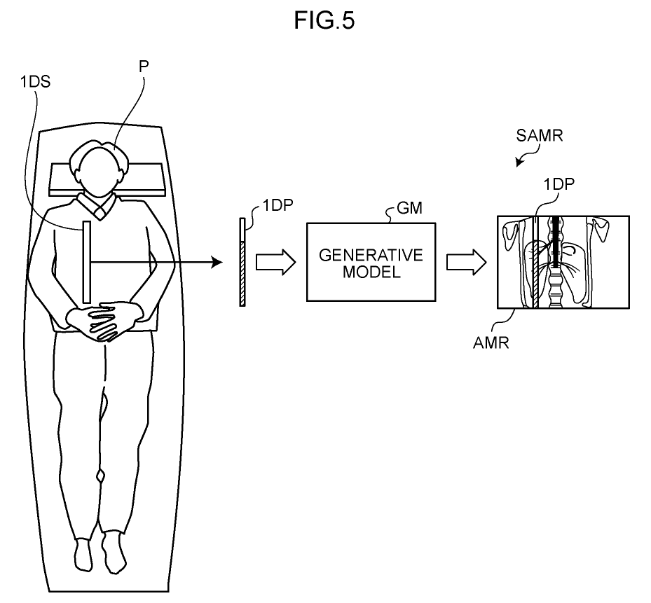

FIG. 5 is a view illustrating an artificial superimposed image SAMR generated in the artificial-medical-image generation process, as an example. As illustrated in FIG. 5, the one-dimensional data 1DP is superimposed onto the artificial MR image AMR. The one-dimensional data 1DP may be highlighted in the artificial MR image AMR on display. In addition, the present embodiment has described an example of superimposing the one-dimensional data 1DP onto the artificial MR image AMR to generate the artificial superimposed image SAMR, however, this example is not to be construed as limiting. For example, the generative model GM can be pretrained to output the artificial superimposed image SAMR. In this case, the operations for superimposing the one-dimensional data 1DP onto the artificial MR image AMR are omissible.

The medical image diagnostic apparatus according to some embodiments described above obtains, by a scan of the subject P, lower-dimensional data which is data lower in dimension than a medical image to be presented to the user. The apparatus then inputs the lower-dimensional data into a pretrained generative model to generate and output an artificial medical image being higher in dimension than the lower-dimensional data. The pretrained generative model has learned to generate an artificial medical image from an input of data being lower in dimension than the medical image. The artificial medical image is for use in localization for a main scan of the subject P. Specifically, the MRI apparatus 100 according to one embodiment obtains, by an MR scan (lower-dimensional scan) of the subject P, lower-dimensional data 1DP which is data lower in dimension than an MR image to be presented to the user. The MRI apparatus 100 then inputs the lower-dimensional data 1DP into a pretrained generative model GM having learned to generate an artificial MR image AMR from an input of the data 1DP being lower in dimension than the MR image, to generate and output an artificial MR image AMR being higher in dimension than the lower-dimensional data 1DP. The artificial MR image AMR is for use in localization for a main scan of the subject P.

In the MRI apparatus 100 of one embodiment, the lower-dimensional data represents one-dimensional MR data acquired by a one-dimensional scan of the subject P or a one-dimensional profile 1DP generated by reconstruction of the one-dimensional MR data. In addition, according to the MRI apparatus 100 of one embodiment, the lower-dimensional data is data generated by an MR scan conducted prior to a main scan of the subject P. The artificial MR image AMR corresponds to a locator image for use in localization for the main scan.

Further, in the MRI apparatus 100 of one embodiment, when the MR image to be presented is a three-dimensional MR image, the lower-dimensional data is one of: the one-dimensional MR data acquired by a one-dimensional scan of the subject P; the one-dimensional profile 1DP generated by reconstruction of the one-dimensional MR data; the two-dimensional MR data acquired by a two-dimensional scan of the subject P; or the two-dimensional image generated by reconstruction of the two-dimensional MR data.

As such, the MRI apparatus 100 of one embodiment can input lower-dimensional measured data into the generative model GM to generate artificial MR images AMR, resulting in reducing occurrence of hallucinations. In addition, the MRI apparatus 100 of one embodiment obtains lower-dimensional data so that it can generate artificial MR images AMR to be used in localization in a shorter length of time than the conventional apparatuses.

Consequently, the MRI apparatus 100 of one embodiment is able to generate the artificial MR image AMR in a shorter length of time while greatly reducing the probability of occurrence of hallucinations. Thus, the MRI apparatus 100 can shorten the examination time taken for the subject P, leading to mitigating a burden of examination on the subject P and improving examination throughput.

Moreover, the MRI apparatus 100 of one embodiment performs positional alignment between the artificial MR image AMR and the lower-dimensional data 1DP to generate an artificial superimposed image SAMR for output by superimposing lower-dimensional data onto the artificial MR image AMR. The MRI apparatus 100 of one embodiment also generates the artificial superimposed image SAMR in a manner that the location of the lower-dimensional data 1DP therein is identifiable.

As a result, the MRI apparatus 100 of one embodiment can allow the user to easily identify the lower-dimensional data 1DP in the artificial superimposed image SAMR. Namely, the MRI apparatus 100 of one embodiment can allow the user to easily know occurrence or non-occurrence of hallucinations in the artificial MR image AMR.

Owing to the features as above, the MRI apparatus 100 of one embodiment can artificially generate locator images in a shorter length of time than the conventional apparatuses. Moreover, the MRI apparatus 100 of one embodiment can eliminate concerns about the generative model GM from the perspective of the relevant regulations. As such, the MRI apparatus 100 of one embodiment can implement an effective workflow of the MR examination.

### FIRST MODIFICATION

A first modification involves further inputting information on the subject P (hereinafter, additional information) into the generative model GM to generate artificial medical images such as the artificial MR image AMR. The additional information refers to, for example, at least either information indicating a region of the subject P (a region to be imaged) in the lower-dimensional data or an optical image of the subject P. In addition to the above example, the additional information may contain, for example, a disease name, age, gender, height, or weight of the subject P included in the examination order.

The generative model in this modification is pretrained using additional information as to training data and ground-truth data. The artificial-medical-image generation process in this modification is identical to the one in some embodiments except for the further input of the additional information to the generative model. Thus, a description of the artificial-medical-image generation process in this modification is omitted.

The MRI apparatus 100 of this modification described above further inputs information as to the subject P in the lower-dimensional data 1DP into the generative model GM to generate the artificial MR image AMR. In the MRI apparatus 100 of this modification, the information as to the subject P represents at least either information indicating a region of the subject P relative to the lower-dimensional data 1DP or an optical image of the subject P. As such, the MRI apparatus 100 of this modification inputs the additional information as to the subject P into the generative model GM in addition to the lower-dimensional measured data as to the subject P to generate the artificial MR image AMR. Thereby, the MRI apparatus 100 can further reduce occurrence of hallucinations. The rest of the effects are similar to or the same as those of the embodiments, therefore, a description thereof is omitted.

### First Application

A first application is intended to implement or provide the artificial-medical-image generation apparatus 10 as a variety of server devices such as a cloud server. The structure and configuration of the artificial-medical-image generation apparatus 10 in FIG. 1 are presented for illustrative purpose only and not to be construed as limiting. For example, the artificial-medical-image generation apparatus 10 may further include the display 143 and/or the input apparatus 141, a communication interface, and else.

The control function 133 of the artificial-medical-image generation apparatus 10 controls the artificial-medical-image generation apparatus 10 as a whole but does not include a function to control the respective elements of the MRI apparatus 100. In using the artificial MR image AMR as a locator image, the artificial-medical-image generation apparatus 10 uses the interface function 131 to transmit the artificial MR image AMR to the MRI apparatus being a sender of the lower-dimensional data. Note that, when the artificial-medical-image generation apparatus 10 is in the form of a cloud server, the images generated by the generative model GM (artificial MR images AMR) may not be transmitted to the sender of the lower-dimensional data (MRI apparatus).

The obtaining function 134 of the artificial-medical-image generation apparatus 10 obtains the lower-dimensional data from the MRI apparatus via a network, in coordination with the interface function 131. The rest of the functions and configuration of the artificial-medical-image generation apparatus 10 are similar to or the same as those of the embodiments, therefore, a description thereof is omitted. In addition, in the artificial-medical-image generation process performed by the artificial-medical-image generation apparatus 10, the operation in step S1 is omitted and the lower-dimensional data is obtained from the MRI apparatus via a network in step S2.

The artificial-medical-image generation apparatus 10 described above obtains lower-dimensional data 1DP which is data lower in dimension than a medical image to be presented to the user. The artificial-medical-image generation apparatus 10 then inputs the lower-dimensional data 1DP into the pretrained generative model to generate an artificial medical image being higher in dimension than the lower-dimensional data 1DP for output. The pretrained generative model has learned to generate an artificial medical image from an input of data being lower in dimension than the medical image.

As an example, the output function 138 of the artificial-medical-image generation apparatus 10 outputs the resultant artificial medical image to the source of the lower-dimensional data 1DP, e.g., the MRI apparatus. Alternatively, the output function 138 may output the artificial medical image to the display incorporated in the artificial-medical-image generation apparatus 10 or the PACS server. The effects of this application are similar to or the same as those of the embodiments, therefore, a description thereof is omitted.

### Second Application

A second application is intended to implement the technical idea of some embodiments as an X-ray computed tomography (CT) apparatus. In this case the artificial-medical-image generation apparatus 10 may be referred to as an artificial-CT-image generation apparatus. Herein, the medical image diagnostic apparatus incorporating the artificial-medical-image generation apparatus 10 is defined to be an X-ray CT apparatus. In this case, the lower-dimensional data corresponds to projection data or a slice image. The projection data is acquired by an X-ray pencil-beam or narrow fan-beam scan, or a single slice, for instance. The slice image is reconstructed based on the projection data. The projection data corresponds to medical data while the slice image (CT image) corresponds to a medical image.

The artificial-medical-image generation process in the second application corresponds to an artificial-CT-image generation process. The artificial-medical-image generation process in the second application is to be understandable by replacing the MR data and the artificial MR image in FIG. 3 with projection data and an artificial CT image, respectively, therefore, a description thereof is omitted. Also, the effects of the second application are similar to or the same as those of the embodiments so that a description thereof is omitted.

To realize the technical idea of some embodiments by an artificial-medical-image generation method, the artificial- medical-image generation method includes obtaining lower-dimensional data 1DP which is data lower in dimension than a medical image to be presented to a user; inputting the lower-dimensional data 1DP into a pretrained generative model to generate an artificial medical image being higher in dimension than the lower-dimensional data, the pretrained generative model having learned to generate an artificial medical image from an input of data being lower in dimension than the medical image; and outputting the artificial medical image. The medical image represents, for example, an MR image or a CT image. The procedure and effects of the artificial-medical-image generation process to be performed by the artificial-medical-image generation method are similar to or the same as those in some embodiments, so that a description thereof is omitted.

According to any of the embodiments, modification, and applications as described above, it is made possible to use image generative AI to generate artificial medical images while reducing occurrence of hallucinations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An artificial-medical-image generation apparatus, comprising processing circuitry configured to:
obtain lower-dimensional data which is data lower in dimension than a medical image to be presented to a user;
input the lower-dimensional data into a pretrained generative model to generate an artificial medical image being higher in dimension than the lower-dimensional data, the pretrained generative model having learned to generate an artificial medical image from an input of data being lower in dimension than the medical image; and
output the artificial medical image.

2. The artificial-medical-image generation apparatus according to claim 1, wherein
the lower-dimensional data is one-dimensional medical data acquired by a one-dimensional scan of a subject or a one-dimensional profile generated by reconstruction of the one-dimensional medical data.

3. The artificial-medical-image generation apparatus according to claim 1, wherein
the lower-dimensional data is data generated by a scan performed prior to a main scan of a subject, and
the artificial medical image corresponds to a locator image for use in localization for the main scan.

4. The artificial-medical-image generation apparatus according to claim 1, wherein
when the medical image is a three-dimensional image, the lower-dimensional data is one of:
one-dimensional medical data acquired by a one-dimensional scan of the subject;
a one-dimensional profile generated by reconstruction of the one-dimensional medical data;
two-dimensional medical data acquired by a two-dimensional scan of the subject; or
a two-dimensional image generated by reconstruction of the two-dimensional medical data.

5. The artificial-medical-image generation apparatus according to claim 1, wherein
the processing circuitry is configured to further input, into the generative model, information on a subject relative to the lower-dimensional data to generate the artificial medical image.

6. The artificial-medical-image generation apparatus according to claim 5, wherein
the information on the subject represents at least either information indicating a region of the subject relative to the lower-dimensional data, or an optical image of the subject.

7. The artificial-medical-image generation apparatus according to claim 1, wherein
the medical image is a magnetic resonance image or a CT image.

8. The artificial-medical-image generation apparatus according to claim 1, wherein
the processing circuitry is configured to
perform positional alignment between the artificial medical image and the lower-dimensional data to generate an artificial superimposed image by superimposing the lower-dimensional data onto the artificial medical image, and
output the artificial superimposed image.

9. The artificial-medical-image generation apparatus according to claim 8, wherein
the processing circuitry is configured to generate the artificial superimposed image in such a manner that a location of the lower-dimensional data in the artificial superimposed image is identifiable.

10. An artificial-medical-image generation method, comprising:
obtaining lower-dimensional data which is data lower in dimension than a medical image to be presented to a user;
inputting the lower-dimensional data into a pretrained generative model to generate an artificial medical image being higher in dimension than the lower-dimensional data, the pretrained generative model having learned to generate an artificial medical image from an input of data being lower in dimension than the medical image; and
outputting the artificial medical image.

11. A medical image diagnostic apparatus, comprising processing circuitry configured to:
obtain lower-dimensional data by a scan of a subject, the lower-dimensional data being data lower in dimension than a medical image to be presented to a user,
input the lower-dimensional data into a pretrained generative model to generate an artificial medical image being higher in dimension than the lower-dimensional data, the pretrained generative model having learned to generate an artificial medical image from an input of data being lower in dimension than the medical image, and
output the artificial medical image, wherein
the artificial medical image is used in localization for a main scan of the subject.
